(19) United States
(12) Patent Application Publication
(10) Pub. No.: US 2012/0067825 A1
(43) Pub. Date: Mar. 22, 2012

(54) EFFICIENT METHODS FOR OPERATION WITH HIGH PRESSURE LIQUIDS

(75) Inventors: Gonzalo G. PIQUE, Oakland, CA (US); Richard L. STOVER, Newton, MA (US); Jeremy MARTIN, Oakland, CA (US)

(73) Assignee: ENERGY RECOVERY, INC., San Leandro, CA (US)

(21) Appl. No.: 13/237,659

(22) Filed: Sep. 20, 2011

Related U.S. Application Data
(63) Continuation of application No. PCT/US2010/027918, filed on Mar. 19, 2010.
(60) Provisional application No. 61/161,977, filed on Mar. 20, 2009.

(51) Int. Cl. C02F 1/52; F17D 1/00; F28D 15/00

(52) U.S. Cl. 210/723; 165/104.28; 137/1

(57) ABSTRACT

Methods for more efficiently carrying out various operations through the use of pressure transfer between streams. The methods are applicable for use in conjunction with a wide range of processes including precipitation reactors (19), subterranean space (49) temperature control systems and exothermic chemical processors (71). Rotary isobaric pressure exchange units (29,55,81) are preferably employed.

### CROSS REFERENCE TO RELATED APPLICATIONS

This application is a continuation of U.S. Application No. PCT/US2010/027918, filed Mar. 19, 2010, which claims priority from U.S. Provisional Application No. 61/161,977, filed Mar. 20, 2009, the disclosures of both of which are incorporated herein by reference.

### BACKGROUND OF THE INVENTION

The invention relates to methods for more efficiently carrying out various high pressure operations or operating with high pressure liquids, such as those involving pressure precipitation, controlling high temperature operations as by cooling high pressure liquid streams and efficient supply and use of liquids in subterranean spaces.

With the cost of power for driving pumps to pressurize liquids steadily increasing throughout the world, it has been important to investigate whether methods of operation involve high pressure liquids can be more efficiently performed to conserve such costly electrical energy. It has been found that there are a number of operations which involve the use of high pressure liquids that can be significantly modified to allow them to operate more efficiently.

### SUMMARY OF THE INVENTION

It has been found that, by carefully conserving the high pressure energy present in high pressure liquids, there are a variety of methods and/or processes involving such liquids that can be more efficiently performed. The key to such conservation is found to lie in the employment of energy recovery devices that are capable of transferring high pressure from one liquid stream to another without dissipating the pressure of the high pressure stream.

In one particular aspect, the invention provides a method for efficiently effecting high pressure precipitation, which method comprises the steps of:

(a) supplying a feedstream having dissolved solutes or colloidal suspensions,

(b) raising the pressure of said feedstream to at least about 500 psi (35 bar),

(c) transferring said high pressure stream of step (b) to a reactor,

(d) treating said high pressure stream in said reactor to cause precipitates to form,

(e) withdrawing a solute-depleted or colloidal suspension depleted stream from said reactor while maintaining the high pressure therein by exchanging said high-pressure of said stream being removed with the feedstream being supplied in step (a) to accomplish a major part of said pressurizing of step (b) and

(f) separating said precipitates from said high pressure liquid.

In another particular aspect, the invention provides a method of efficiently delivering water to a subterranean mine and retrieving it to the surface, which method comprises the steps of:

providing a source of liquid,

effecting gravity flow of a descending stream of said liquid into a mine requiring cooling at least 1000 feet (305 meters) below,

reducing the pressure of said liquid stream to about atmospheric pressure,

utilizing said atmospheric pressure liquid stream in the mine,

increasing the pressure of the used liquid stream by exchanging its pressure with that of the down-flowing liquid stream, and

returning said repressurized used liquid stream to the surface.

In a further particular aspect, the invention provides a method of efficiently adjusting the temperature of a high pressure stream, which method comprises the steps of:

providing a first stream of high pressure liquid of at least about 500 psi (34 bar), which is desired to be heated or cooled while retaining substantially the same pressure,

flowing said first high-temperature liquid stream through a heat-exchanger designed for low pressure operation where it either (1) rejects heat directly into a cooler fluid in order to cool said first stream and produce a second cooler liquid stream having a temperature at least about 50° F. (10° C.) lower, or (2) absorbs heat from a warmer fluid in order to heat said first stream and produce a second warmer stream having a temperature at least about 50° F. (10° C.) higher,

prior to its entry into the heat-exchanger, exchanging the high pressure of said first liquid stream with the second liquid stream exiting from the heat exchanger to produce a depressurized first liquid stream and a repressurized second liquid stream, and

returning said repressurized second liquid stream to said reactor at about the pressure at which said first stream exited.

### DESCRIPTION OF THE FIGURES

FIG. 1 is a schematic drawing showing a method for efficiently carrying out chemical and/or physical reactions at a high pressure.

FIG. 2 is a schematic drawing showing a method for efficiently using a liquid stream of surface water in a subterranean space, such as an operating mine, e.g. to efficiently cool the environment.

FIG. 3 is a schematic drawing showing a method for efficiently cooling a high temperature stream so as to lower its temperature while maintaining substantially the same pressure in the liquid stream, e.g. for the control of an exothermic chemical process.

### DETAILED DESCRIPTION OF THE PREFERRED EMBODIMENTS

It is known that there are a variety of chemical and/or physical processes that operate more efficiently at superatmospheric pressures, for example at pressures at least about 500 psi (35 bar), and particularly at pressures above about 800 psi (55 bar). For purposes of this application, pressures are understood to represent “gauge” pressure, i.e. the amount above atmospheric pressure, unless otherwise indicated. Some of these involve the treatment of proteins, whereas others are concerned with the precipitation of metals from liquid streams containing dissolves solutes or colloidal suspensions. For example, in the field of proteins, there are advantages to treating solutions of insulin and albumin in organic solutions at high pressures, e.g. 1000-2000 psig, to produce desired microparticles. It is also known to treat aqueous solutions of whey at high pressures with carbon dioxide to fractionate the whey proteins and cause their precipitation. There are numerous treatments of solutions of metal ions that can be effectively precipitated under high pressures by treatment with hydrogen and/or sulfur containing gases using techniques which have been generally referred to as pressure precipitation. It is also known to treat colloidal suspensions of ores or other raw materials using acids or the like to cause precipitation of metals under techniques referred to as pressure leaching.

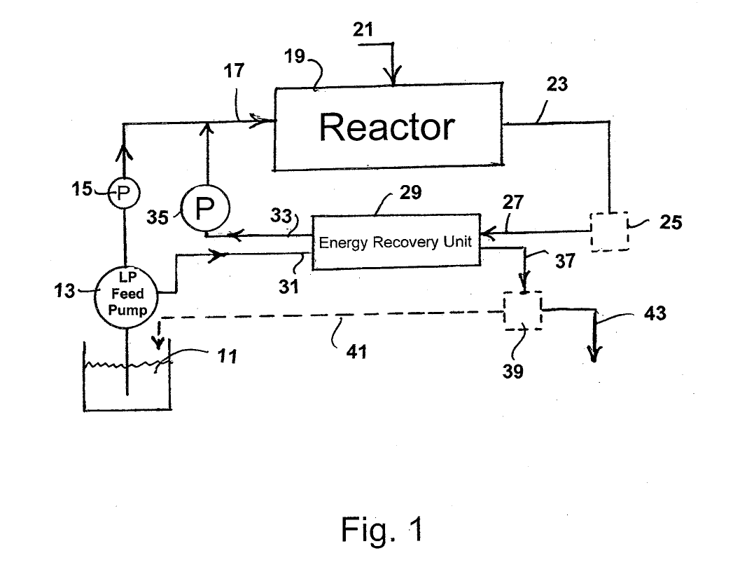

FIG. 1 is a schematic drawing of an exemplary operation of one type of pressure precipitation. A reservoir 11 of liquid is shown for supply at atmospheric pressure to a low pressure feed pump 13. The discharge from the feed pump is split and initially is used to supply a small high pressure pump 15 which is used to deliver liquid to the inlet 17 to a reactor 19 to fill it with high pressure liquid where treatment occurs. Reactants are optionally supplied to the reactor 19 through the line 21 which may include carbon dioxide at superatmospheric pressure. Once treatment has progressed sufficiently so as to effect precipitation, a stream is withdrawn through an outlet line 23 and may optionally be delivered to a separator 25 where granular precipitates can be removed while the stream is at high pressure. Examples of such processes include those shown in U.S. Pat. Nos. 5,925,737 and 6,562,952.

The high pressure liquid stream from the reactor 19 is supplied to an inlet line 27 that enters the right-hand end of an energy recovery unit 29 in FIG. 1. Although a rotary energy recovery unit may be preferred, such as one shown in U.S. Pat. Nos. 5,338,158 and 6,659,731, other types of such isobaric devices as known in this art may be used, such as the Dweer energy recovery device marketed by Calder AG. The low pressure pump 13 also supplies a stream of low pressure feed liquid to an inlet 31 at the opposite end of the energy recovery unit 29. The preferred energy recovery unit will operate without any auxiliary motor drive and transfer the pressure of the high pressure exit stream exiting the reactor to a feedstock stream being supplied by the low pressure pump 13 to the inlet 31. As a result of this transfer, a high pressure feed stream exits an outlet 33 at the left-hand end of the unit 29 at a pressure that is, for example, about 97% of the pressure of the stream exiting the reactor 19. A circulation pump 35 draws liquid exiting the energy recovery unit and overcomes line losses in feeding this stream to the inflow inlet 17 to the reactor. So long as the system is operating, substantially the entire flow of liquid being treated is pressurized by the energy recovery unit 29, and the high pressure pump 15 operates little if at all. The liquid stream that exited the reactor and transferred its high pressure in the energy recovery unit 29 exits via an outlet 37 at the right-hand end of the unit and can optionally be fed to a separator 39, particularly if one was not included in the line between the reactor 19 and the energy recovery unit 29. For some processes, granular precipitates can be separated as microparticles while the exit stream is at high pressure; whereas, in others, it is more efficient to separate the precipitates following pressure reduction. The disposition of the liquid discharge from the optional separator 39 may, depending on the process in question, be a partial return as a recycle stream 41 to the reservoir 11 of supply liquid, or instead it may be totally directed through a line 43 leading to a further process step.

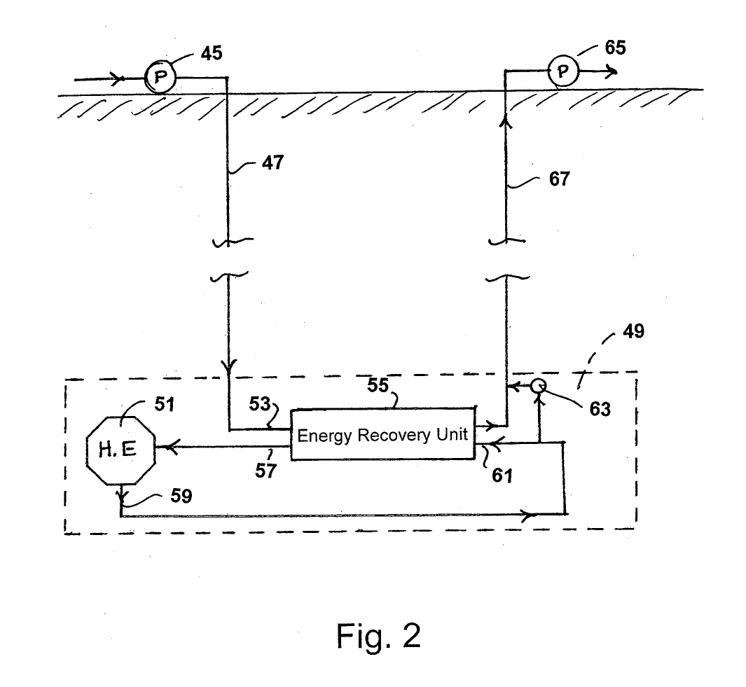

Depicted schematically in FIG. 2 is an exemplary operation of efficiently cooling subterranean spaces which, as a result of the heat of the earth at significant distances underground, e.g. about 1000 feet (305 meters), and the heat generated by electric motors and the like, will have temperatures that rise above comfort levels and require cooling. In addition, there are other needs for water in subterranean mines such as for washing, cleaning, etc., where the used stream of water also needs to be returned to the surface. Cooling of said subterranean spaces, for example, can be efficiently performed through the supply of a stream of cool water that is pumped via a simple low pressure pump 45 that fills a downflow line 47 leading downward, perhaps 2,300 feet (750 meters) or more, to an operating subterranean mine 49. Before the cool liquid stream is supplied to a heat exchanger 51, for example, one with a large surface area across which the atmosphere in the appropriate level of the mine will be circulated, it is supplied to the high pressure inlet 53 of an energy recovery unit 55 as similar to that described above. In this unit, the pressure may be dropped from about 750 psi (52 bar) to about atmospheric pressure; it is then fed to the heat exchanger 51 from the low pressure exit outlet 57 of the unit. Because the heat exchanger 51 need not be constructed to contain and operate with high pressure liquids, it can be made at much lower cost and will produce higher efficiency as a result of superior heat transfer through much thinner walls. The exit stream 59 of heated liquid from the heat exchanger 51 is then returned to the opposite end of the energy transfer unit 55 where it enters through a low pressure inlet 61, and its pressure is raised back to close to the pressure at which the descending stream entered the inlet pipe 53 at the left-hand end of the unit. Because there will be some small amount of lubrication leakage of high pressure liquid through the unit 55, a small injection pump 63 is provided to accommodate the slight additional volume of low pressure liquid by bypassing the energy recovery unit as shown. In this manner, about 97% of the pressure of the descending stream is recovered which is sufficient to return the now warm liquid to the surface. The line losses in the downflow and upflow lines of about 90 psi (6 bar) can likely be conveniently overcome with pressure supplied by the surface pump 45. Line losses can alternatively be compensated for with a suction pump 65 in the upflow line that may conveniently be located at ground level.

Study of the overall operation shows that effective use of cooling or cleaning liquid in a subterranean space is very economically accomplished through this overall method. Advantage is taken of the gravity flow of surface level liquid down to the operating mine level, where it is most efficiently used to absorb heat from the atmosphere in a low pressure heat exchange device, which is made possible by radically reducing its pressure, or is used for other operational purposes. Importantly, such reduction of pressure to take advantage of low pressure heat exchange devices is done in a manner so as to supply nearly all of the energy needed to return the used liquid stream to the surface as a result of the strategic placement of such an energy recovery device. Because only a minimum amount of energy needs to be expended by the surface pump and the injection pump 63, it can be seen that the overall situation is an extremely favorable one, particularly when an energy recovery unit that requires no auxiliary power train is utilized. For example, very effective cooling of a subterranean installation is provided merely by supplying the cool stream of liquid through the entry point at ground surface level and driving the surface pump 45 to supply about 1% of the pressure head necessary to return the stream to the surface.

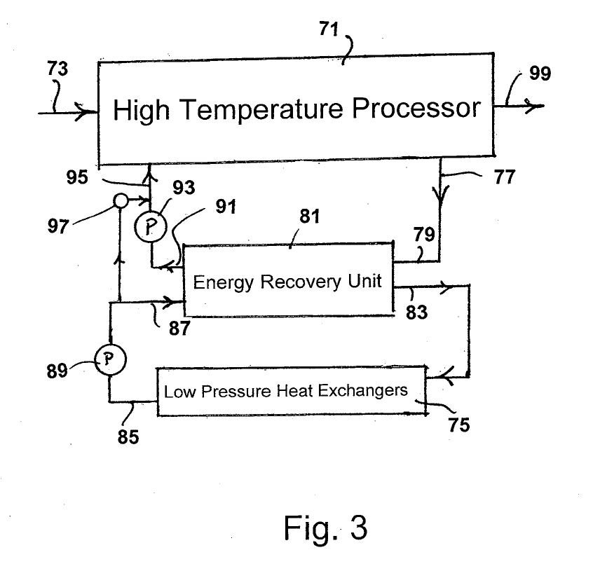

FIG. 3 schematically illustrates a high pressure process that is proceeding in a reactor 71 or the like, fed by an incoming stream 73. The process is such that a lowering of the temperature, but not the pressure, of the liquid materials is needed. One such example would be a chemical process that is highly exothermic in nature so that cooling is required to keep the reaction under control. For other processes that are endothermic, it may be desirable to instead supply heat. Although various cooling or heating methods might be employed, FIG. 3 illustrates a particularly economical arrangement which utilizes low pressure heat exchangers 75 of the type just hereinbefore discussed. Such provide both capital cost savings and more efficient heat exchange. A cooling application is described where a side stream 77 of high pressure, high temperature liquid is removed from the main processing vessel 71 through an outlet and delivered to a high pressure inlet 79 into an energy recovery unit 81. The construction of such units is such that the inflow and outflow of streams of liquid effectively drive the pressure exchange, thus requiring no external power source. Moreover, there is no significant pressure drop in the line 77 exiting the processor 71, thus maintaining the desired high pressure in the process chamber and avoiding any dissipation thereof In the energy recovery unit 81, the pressure of the high temperature side stream is transferred to a liquid stream entering the opposite end of the unit, thereby reducing its pressure to essentially the pressure at which that stream enters the other end. For example, a high temperature stream which exits the main vessel 71 at about 1000 psi (69 bar) may have its pressure drop to just above atmospheric, e.g. about 10 psi (0.7 bar) in the outlet 83 from the unit 81 which leads to the low pressure heat exchangers 75. Such high surface area heat exchanger can be economically constructed to handle relatively low pressure liquids, and the temperature of the stream can be efficiently dropped from, for example, about 400° F. (204° C.) to about 100° F. (38° C.) by heat exchange against the atmosphere, or any other available gas or liquid depending upon the heat exchanger design. It should be understood that, for a heating application, an appropriate rise in temperature of at least about 50° F. (10° C.) can be efficiently effected; greater temperature rises may result in even greater economies. An exit line 85 from the heat exchanger is connected to the low pressure inlet conduit 87 at the other end of the energy recovery unit 81. A small pump 89 is preferably included in this line to compensate for line losses through the heat exchangers.

In the energy recovery unit 81, the pressure of the now cooled liquid stream is returned to a figure equal to about 97% of the pressure of the original high temperature exit stream 77 from the vessel 71 that entered the inlet conduit 79. The high pressure outlet 91 from the rotary energy recovery unit 81 is connected to a side inlet to the main vessel 71 to return the stream thereto, and a circulation pump 93 is provided in this line 95 to draw the fluid exiting from the energy recovery unit and deliver this return stream to the main vessel, where the returning, cool side stream mixes with the liquid in the vessel and effects the desired temperature control. A small pump 97 is also included to accommodate lubrication leakage from the high pressure side of the unit 81. A high pressure exit stream 99 leaves the vessel 71 at about the desired targeted temperature.

Overall, it can be seen that such an arrangement provides an extremely effective way of economically and efficiently maintaining desired a reaction temperature in a reaction zone or simply drastically reducing the temperature of a product stream while maintaining its high pressure as it is being transferred to a further point in an overall operation. Economy results not only from the ability to utilize low pressure heat exchangers having far less capital cost and greater efficiency of operation, but also through a minimizing of the need for pumping power to effect such desired cooling.

Although the invention has been described with regard to certain preferred embodiments, it should be understood that various changes and modifications, as would be obvious to one having ordinary skill in this art, may be made without departing from the scope of the invention, which is set forth in the claims appended hereto.

1. A method for efficiently effecting high pressure precipitation, which method comprises the steps of:
(a) supplying a feedstream having dissolved solutes or colloidal suspensions,
(b) raising the pressure of said feedstream to at least about 500 psi (35 bar),
(c) transferring said high pressure stream of step (b) to a reactor,
(d) treating said high pressure stream in said reactor to cause precipitates to form,
(e) withdrawing a solute-depleted or colloidal suspension depleted stream from said reactor while maintaining the high pressure therein by exchanging said high-pressure of said stream being removed with the feedstream being supplied in step (a) to accomplish a major part of said pressurizing of step (b) and
(f) separating said precipitates from said high pressure liquid.

2. The method according to claim 1 wherein said separating is carried out prior to said pressure-exchanging.

3. The method according to claim 1 wherein said separating is carried out after said pressure-exchanging.

4. The method according to claim 1 wherein said pressure exchanging is effected in an isobaric rotary pressure exchange unit.

5. The method according to claim 1 wherein said feedstream has dissolved proteins.

6. The method according to claim 5 wherein said high pressure stream is treated in said reactor with carbon dioxide to cause precipitates to form.

7. The method according to claim 6 wherein said pressure exchanging is effected in an isobaric rotary pressure exchange unit.

8. The method according to claim 1 wherein said feedstream contains metal ions.

9. The method according to claim 8 wherein said high pressure stream is treated in said reactor with sulfur-containing compounds which cause insoluble metal sulfides to form.

10. The method according to claim 9 wherein said pressure exchanging is effected in an isobaric rotary pressure exchange unit.

11. A method of efficiently delivering water to a subterranean mine and retrieving it to the surface, which method comprises the steps of:
providing a source of liquid,
effecting gravity flow of a descending stream of said liquid into a mine requiring cooling at least 1000 feet (305 meters) below,
reducing the pressure of said liquid stream to about atmospheric pressure,
utilizing said atmospheric pressure liquid stream in the mine,
increasing the pressure of the used liquid stream by exchanging its pressure with that of the down-flowing liquid stream, and
returning said repressurized used liquid stream to the surface.

12. The method according to claim 11 wherein said depressurized liquid stream exiting said pressure-exchanging step is caused to flow through a low pressure heat-exchanger where its temperature rises at least about 100° F. (38° C.) to produce a heated liquid stream that is then repressurized and returned to the surface.

13. The method according to claim 11 wherein the first liquid is used in a cleaning operation at atmospheric pressure to produce said used liquid stream.

14. The method according to claim 11 wherein said pressure-exchanging is effected in an isobaric rotary energy recovery unit.

15. A method of efficiently adjusting the temperature of a high pressure stream, which method comprises the steps of:
providing a first stream of high pressure liquid of at least about 500 psi (34 bar), which is desired to be heated or cooled while retaining substantially the same pressure,
flowing said first high-temperature liquid stream through a heat-exchanger designed for low pressure operation where it either (1) rejects heat directly into a cooler fluid in order to cool said first stream and produce a second cooler liquid stream having a temperature at least about 50° F. (10° C.) lower, or (2) absorbs heat from a warmer fluid in order to heat said first stream and produce a second warmer stream having a temperature at least about 50° F. (10° C.) higher,
prior to its entry into the heat-exchanger, exchanging the high pressure of said first liquid stream with the second liquid stream exiting from the heat exchanger to produce a depressurized first liquid stream and a repressurized second liquid stream, and
returning said repressurized second liquid stream to said reactor at about the pressure at which said first stream exited.

16. The method according to claim 15 wherein said first high pressure stream is removed from a process reactor and said second stream is returned thereto.

17. The method according to claim 15 wherein the temperature of said first high pressure stream is decreased.

18. The method according to claim 17 wherein said pressure-exchanging is effected in an isobaric rotary energy recovery unit.

19. The method according to claim 15 wherein the temperature of said first high pressure stream is increased.

20. The method according to claim 19 wherein said pressure-exchanging is effected in an isobaric rotary energy recovery unit.
